(19) United States
(12) Patent Application Publication
(10) Pub. No.: US 2020/0260888 A1
(43) Pub. Date: Aug. 20, 2020

(54) INFUSER DEVICES FOR USE WITH BEVERAGE DRINKING CONTAINERS

(71) Applicants: W. Grover Coors, Golden, CO (US); Thomas Alfred Waller, Redlands, CA (US)

(72) Inventors: W. Grover Coors, Golden, CO (US); Thomas Alfred Waller, Redlands, CA (US)

(21) Appl. No.: 16/276,569

(22) Filed: Feb. 14, 2019

(51) Int. Cl. A47G 19/16; B65D 85/804; A47J 31/00; A47J 31/20

(52) U.S. Cl. CPC A47G 19/16; A47J 31/20; A47J 31/005; B65D 85/8043

(57) ABSTRACT

An infuser device for use with a beverage drinking container comprises a rigid post extending a length from an attachment point with a lid disposed over a drinking container opening. An infuser container is attached adjacent an end of the post opposite the lid, wherein the infuser container includes a chamber to accommodate a volume of infusant therein. The infusant container may have a rigid or movable body and is removably attached to the post. At least a portion of the infuser container is porous to facilitate passage of liquid into and out of the chamber. An axial position of the post relative to a sidewall of the drinking container remains constant independent of a tilt angle of the drinking container. In an example, the infuser post and infuser container are disposable for use with a disposable beverage drinking container and lid.

### FIELD

Infuser devices as disclosed herein are constructed for use in making beverages or the like and, more particularly, are specially configured for use in making beverages within a drinking container including a volume of liquid within which the device is disposed to provide a controlled degree of infusing a material in the device with the liquid in the drinking container.

### BACKGROUND

Many types of hot beverages are prepared by brewing an organic ingredient such as tea, coffee, herbs and the like, in hot water. Taste and aroma of the beverage are enhanced by steeping, which involves keeping the organic ingredient, such as tea leaves or the like, in direct contact with hot water for a prescribed period of time. Prior to drinking the resulting liquid, the organic matter must be filtered or strained out. One common way to do this is to encapsulate the organic matter in a device called an infuser, that permits hot water to percolate freely to the inside but prevents the organic matter from escaping to bulk liquid on the outside by use of a screen or porous membrane. The familiar tea bag is one example.

In order to properly prepare tea made from, e.g., loose leaf tea, it is necessary to steep the leaves in hot water for a prescribed period of time. Prolonged steeping can damage the taste and aroma of the beverage, typically resulting in bitter taste. As a consequence, loose leaf tea is typically placed in a basket strainer, called an infuser, that is left immersed in the hot water for a period of time, and then removed prior to drinking. A common feature of all infusers used in the past is that some provision has been made to remove the infuser from the brewed liquid prior to consumption. However, the added inconvenience of removing the infuser from the drinking container and then disposing it afterwards has tended to dis-incentivize hot tea drinking, as opposed to iced-tea or coffee drinking, where the infuser is not part of the final processes. Tea bags and tea balls have long been used as infusers intended to be left in the drinking container or cup, but drinking around them is inconvenient because their position in the cup is not fixed when the cup is tilted for drinking. Additionally, as noted above, leaving such infuser within the drinking container leads to oversteeping resulting in the beverage eventually having a bitter taste. Therefore, most infusers used with loose leaf tea are intended to be removed from the cup prior to consumption.

Accordingly, in view of the above, it is desired that an infuser device be constructed in a manner capable of enabling a desired material to be infused for purposes of making a beverage, while also reducing or eliminating the possibility of oversteeping. It is also desired that such infuser device be constructed in a manner that provides this function without requiring the user to remove it from the drinking container while providing a desired beverage taste and aroma, thereby eliminating the inconvenience associated with such conventional infuser devices describe above. It is further desired that such device also be constructed in a manner that permits its use with common drinking containers having removable lids, wherein such drinking containers may be in the form of disposable containers or reusable drinking containers, such as motion mugs and the like use for transporting hot beverage contents and that are specifically configured to prevent or minimize spilling of the container contents during transportation and/or use.

### SUMMARY

An infuser device for use with a beverage drinking container as disclosed herein comprises a post extending a length from an attachment point with a lid disposed over a drinking container opening, wherein the post is a rigid construction. An infuser container is attached adjacent an end of the post opposite the lid, wherein the infuser container includes a chamber to accommodate a volume of infusant therein. In an example, the post end opposite the lid is configured to provide a removable attachment with portion of the infuser container. In an example, the infuser container has a rigid body and is removably attached to the post. In an example, the infuser container has a movable body and is removably attached to the post. In an example, the post end opposite the lid comprises a channel configured to accommodate at least a portion of the infuser container therein. In such example, one or both of the infuser channel and the infuser container include a surface feature or a retainer element configured to complement one another to retain attachment of infuser container in the channel. In such example, the retainer element is interposed between a portion of the infuser container and the channel and is disposed within a surface feature of the channel.

A least a portion of the infuser container is porous to facilitate passage of liquid into and out of the chamber. An axial position of the post relative to a sidewall of the drinking container remains constant independent of a tilt angle of the drinking container. In an example, the infuser post and infuser container are disposable for use with a disposable beverage drinking container and lid. In an example, the infuser container is partially or completely covered with liquid disposed in the beverage drinking container when the liquid in the drinking container is in a filled state, and wherein the infuser container is not contacted by the liquid when the liquid in the drinking container is in a used or diminished state caused by removal of the liquid from the drinking container during use.

A method for using infusing a material with a liquid disposed within a drinking container as disclosed herein comprises subjecting an infusant disposed within an infusion container to contact with a liquid, wherein the liquid is disposed within a beverage drinking container, and wherein the infusion container is attached to a post extending from a lid disposed over an opening of the beverage drinking container, wherein the post is rigid and has a fixed axial length. The extent of contact between the infusant and the liquid is controlled such that when the beverage drinking container contains liquid volume in a filled state the liquid is in contact with the infusion container and infusant, and wherein as the liquid is withdrawn from the beverage drinking container during use the extent of contact between the liquid and the infusion container and infusant diminishes to zero. As noted above, in an example the post remains in a fixed position within the beverage drinking container as the beverage drinking container is tilted during use and removal of the liquid by a user.

### BRIEF DESCRIPTION OF THE DRAWINGS

Advantages of embodiments of the infuser devices and constructions as disclosed herein will be apparent from the following detailed description of the exemplary embodiments, which detailed description should be considered in conjunction with the accompanying figures.

FIGS. 1A and 1B illustrate a side view and top view of an example infuser device post used with an infuser device as disclosed herein;

FIGS. 2A to 2C illustrate side views of an example infuser device as disclosed herein comprising the post of FIG. 1, and as disposed within a liquid drinking container at different liquid container orientations and at different container volume levels;

FIG. 3 illustrates a side view of an example infuser device post used with an infuser device as disclosed herein

FIG. 4 illustrates a perspective view of an example infuser device container used with an infuser device as disclosed herein;

FIGS. 5A and 5B illustrate side and top views of an example infuser device post in the form of a clamp used with an infuser device as disclosed herein;

FIG. 6 illustrates a perspective view of the example infuser device post as illustrated in FIGS. 5A and 5B;

FIGS. 7A and 7B illustrate side views of the example infuser device post of FIGS. 5A, 5B and 6 as combined with an infuser device container used with an infuser device as disclosed herein; and

FIGS. 8A to 8C illustrate side views of the example infuser device as disclosed herein comprising the infuser device clip and infuser container of FIGS. 5A, 5B, 6, 7A and 7B, and as disposed within a liquid drinking container at different drinking container orientations and at different drinking container volume levels.

### DETAILED DESCRIPTION

Infuser devices and constructions as disclosed herein are specifically engineered to accommodate a volume of material, such as tea, coffee, herbs and the like, infusion with a liquid that is disposed within a container, e.g., a beverage drinking container. The infuser device is configured so that the contents of such material remains at a fixed position within the drinking container such that as the liquid in the drinking container is reduced or consumed the liquid level moves away from and out of contact with such material to reduce or eliminate over steeping and the undesired aroma and taste associate therewith. Such infuser devices as disclosed herein are configured to accommodate attachment with disposable drinking containers with lids and reusable containers with lids, and are formed from materials, such as plastic, wood, metal and the like, capable of withstanding high liquid temperatures, such as the boiling point of water and the like, for the purposes of carrying out the intended function in a hot-beverage end-use application.

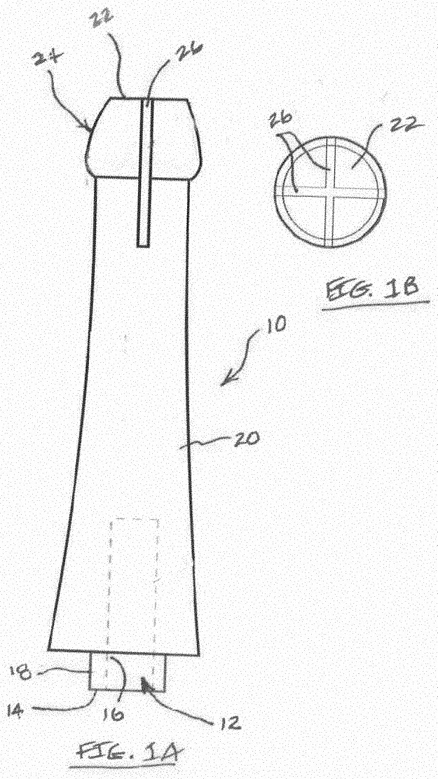

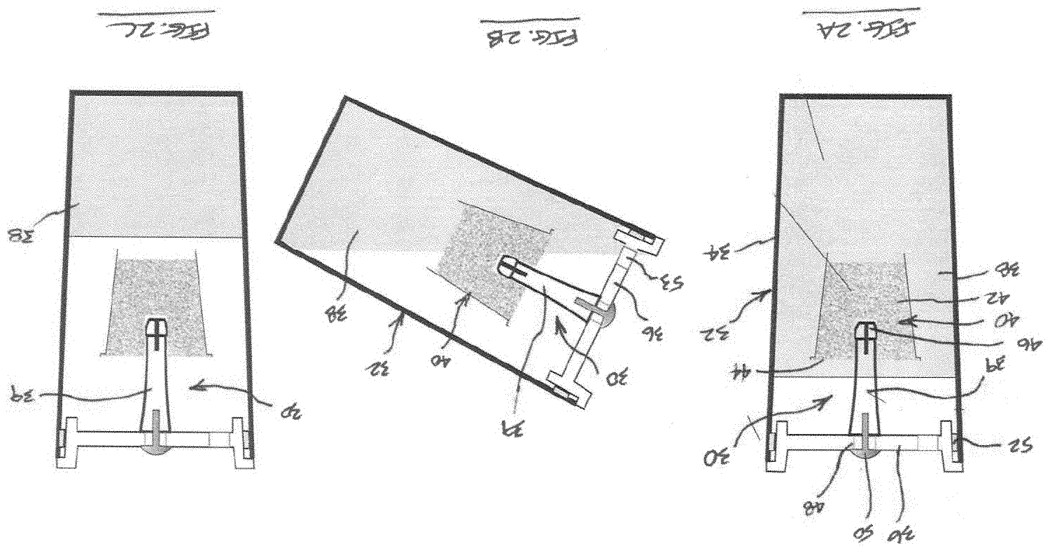

FIGS. 1A and 1B illustrate an example post or shaft 10 as used with infuser devices as disclosed herein. The shaft includes an attachment feature 12 at one of its axial ends 14 that is configured to promote attachment with a drinking container lid along an inside surface of such lid. The attachment feature may be configured to promote attachment by conventional means such as a threaded attachment with another attachment member or the like to fixedly attach the post 10 to the lid (as shown in FIGS. 2A to 2C). Alternatively, the attachment feature may be configured to provide a less permanent attachment to the lid for easy or releasably disconnection therewith. In an example embodiment, the attachment feature 12 is configured to accommodate threaded connection with another attachment element, e.g., in the form of a thread element such as a screw or the like, for use with reusable beverage drinking containers. In such embodiment, the attachment feature is in the form of a threaded hole 16 extending a depth from the end 14, and the end includes a neck 18 positioned at the axial end of end 14 having a reduced diameter and configured to fit within a complementary opening in a lid of a drinking container. In a particular example, the post 10 may be used with a standard, reusable 20 oz. hot beverage tumbler such as one sold under the mark YETI, which is a vacuum sealed, double wall stainless steam tumbler with gasket sealed lid. In an example, the post when attached to the lid forms a leak-tight seal therewith. If desired, a seal element may be used and interposed between the post end 14 and the lid.

The post includes a body 20 that extends from end 14 to an opposed end 22 that may be configured having a cylindrical or any other shape, which shape is not intended to be limited within the scope of the infuser devices as disclosed herein. In an example embodiment, the post body 20 is formed from a plastic material, and the post may be molded or machined and have a one-piece/integral construction. A feature of the post 10 is that its axial length is fixed and is provided having a length that is desired for the purpose immersing a material, such as tea, coffee, herbs or the like, a desired depth within a liquid volume within a drinking container for infusion.

In an example, the post end 22 is configured to promote and provide removable attachment with an infuser container (as shown in FIGS. 2A to 2C). In an example, the post end 22 is configured having an outer surface feature 24 designed to promote retained attachment with the infuser container. In an example, the post end 22 may include one or more reliefs 26 extending axially inwardly a distance from the end 22 to enable reversible inward contraction for insertion of the end 22 into an accommodating surface feature or cavity of the container, to thereby provide a desired releasable attachment therewith. In an example, the post end 22 include two reliefs 26 that are in the form of removed cross-cut portions that extend a distance from the post end 22 that are adjacent the outer surface feature 24. In the example illustrated, the post end surface feature 24 is in the form of a flared outer edge extending radially outwardly a distance from the post body surface that decreases in diameter moving towards the post end 22. It is to be understood that this is but one example embodiment of how the post end 18 may be configured to accommodate removable attachment with the infuser container, and that other attachment configurations known in the art are understood to be within the scope of this description.

FIGS. 2A to 2C illustrate an example infuser device 30 as disclosed herein as combined within a liquid drinking container 32 comprising a housing 34, a lid 36 disposed over an open end of the container housing, and comprising a volume of liquid 38 within the drinking container. FIG. 2A shows an example infuser device 30 comprising the post 39 as illustrated in FIG. 1 and described above as attached with an infuser container 40, wherein the infuser container 40 is configured to accommodate a volume of material or infusant, such as coffee, tea, herbs or the like, therein to be infused by the liquid 38, which infusion is possible by the use of a porous member 42 surrounding the material. The infuser container 40 includes a top member 44 that is configured to accommodate releasable attachment with the post end 46 as described above. The post 39 is attached at end 48 to the drinking container lid 36 by an attachment element 50 extending through the lid. The lid 36 is removably attached to the housing open end, and in this example includes an optional annular seal 52 to provide a leak-tight seal between the lid and drinking container housing. The infusion device 30 has a post length that is designed to cause the volume of material in the infuser container 40 to be completely immersed by the liquid volume for infusion when the drinking container is in a filled condition. In an example, once the liquid drinking container 32 is in a filled position, it may remain in a vertical position for an amount of time until steeping is complete. After steeping, the infuser device 30 or the infuser container 40 may be removed from the liquid drinking container 32, or it may remain in place.

FIG. 2B illustrates the relationship of the infuser device 30 to the drinking container 32 and the liquid volume 38 inside the drinking container when the infuser device 30 is left in the drinking container 32 and the drinking container 32 is tilted into a position for use or drinking, or otherwise removing a volume of the liquid volume from the drinking container, e.g., through an opening 53 along a side of the lid 36. As illustrated, in such a use position, the infuser device 30 position relative to the drinking container does not change, i.e., the infuser device does not tilt or move radially relative to the drinking container housing. As illustrated, depending on the liquid volume level in the drinking container, when the drinking container 32 is moved into a drinking position, the extent of contact between the liquid and the infuser container 40 and infusant therein is reduced, and such continues to be reduced as the volume of liquid within the liquid drinking container continues to be reduced through user drinking, thereby operating to reduce the steeping process as the liquid is being removed from the liquid drinking container.

FIG. 2C illustrates the relationship of the infuser device 30 to the drinking container 32 and the liquid volume 38 inside the drinking container when the infuser device is left in the drinking container, the drinking container is in a vertical position, and a sufficient volume of the liquid has been removed from the drinking container so that the liquid no longer contacts the infuser container 40, i.e., the liquid level is below the infuser device, thereby inhibiting further steeping. As noted above, a feature of the infuser device as disclosed herein is that it is specifically configured to limit the amount of steeping of an infusant without having to be removed from a liquid drinking container.

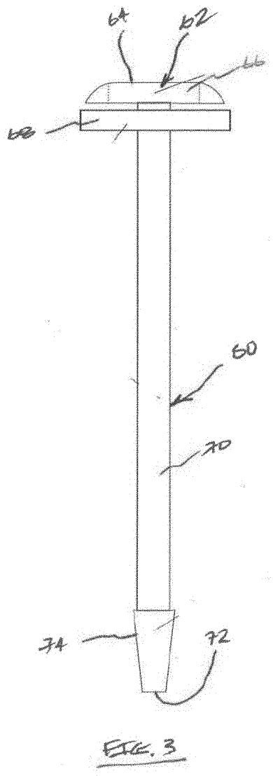

FIG. 3 illustrates an example post or shaft 60 as used with infuser devices as disclosed herein. The post 50 includes an attachment feature 62 at one of its axial ends 64 that is configured to promote attachment with a drinking container lid. In this embodiment, the post is configured to promote use as a disposable element that may be used with a disposable infuser container. The attachment feature 62 may be provided in the form of an elongate tab 66 configured to fit through a complementary elongate opening in a drinking container lid, where turning the tab 66 operates to provide an attachment with the lid between the tab 66 and a collar 68 disposed adjacent the elongate tab. This is but one example attachment mechanism and it is to be understood that other conventional attachment mechanisms may be used and be within the scope of this disclosure. The post includes a body 70 that extends and axial length to an opposite end 72 that is configured having a surface feature 74 to promote attachment with an infuser container. In an example, the surface feature 74 may be provided in the form of a barb to promote engagement and attachment with the infuser container, but other configurations of surface features that operate to provide such an attachment are understood to be within the scope of this disclosure. The post may be formed from the same types of materials described above with respect to the post illustrated in FIG. 1. As indicated, the post 60 in this example may be disposable, and is configured having a desired length to promote immersion of the infusion container in a volume of liquid as discussed above.

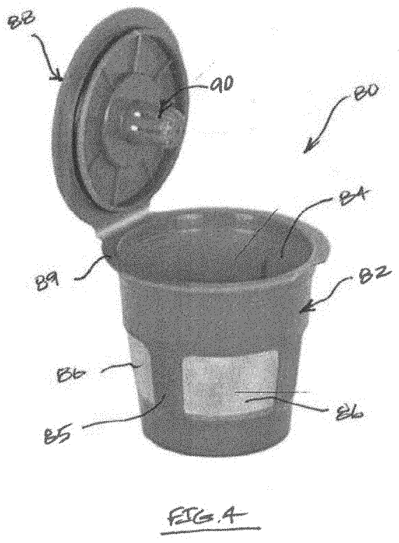

FIG. 4 illustrates an example infuser container 80 as used with infuser devices as disclosed herein. The infuser container 80 comprises a body 82 comprising a chamber 84 configured to accommodate a desired volume of an infusant therein. In an example, the body includes sidewalls 85 comprising a porous material 86 to enable passage of a liquid into the chamber to contacting the infusant to promote desired infusion, which porous material may be a membrane material or screen material. A lid 88 is attached at an open end 89 of the body 82, and may be removable therefrom or may be hingedly or otherwise attached, and that may be configured to snap shut over the body open end. The lid includes an attachment member 90 disposed at a top surface and that is configured to complement and promote attachment the and end of the post as described above. In an example, the attachment member 90 is in the form of a recessed opening that extends a depth from the lid and that is configured to accommodate the attachment feature of the post end therein to provide an attachment fit with the post. When the infuser device comprising the assembled post and container are disposed within a liquid drinking container comprising a volume of liquid, steeping of the infusant takes place by the liquid, e.g., hot water, percolating through the porous material 86 of the container 80. Example of infuser containers that may be used with infuser devices as disclosed herein include those that are commercially available, such as a coffee pod produced by Eco-Fill™, and those that are specially developed for use with the infuser device as disclosed herein that are configured to provide the functionality herein described.

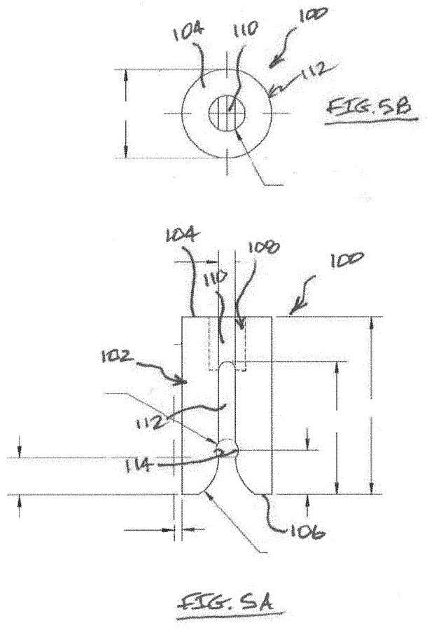

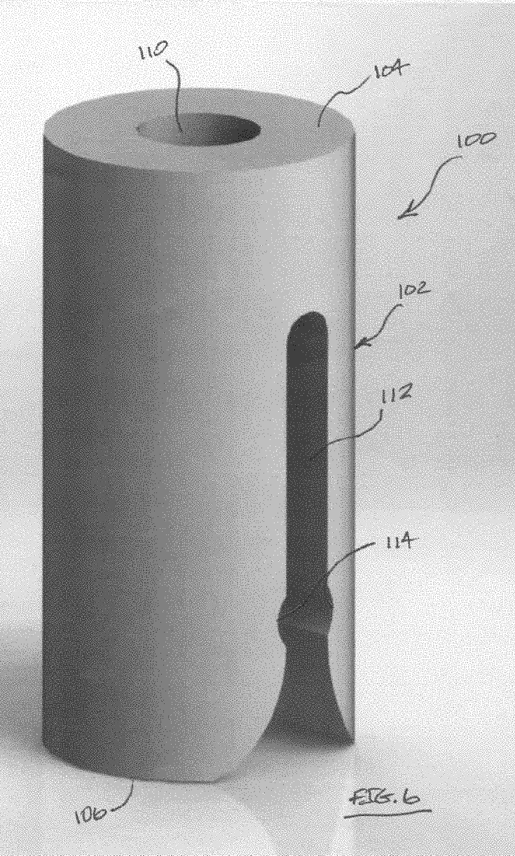

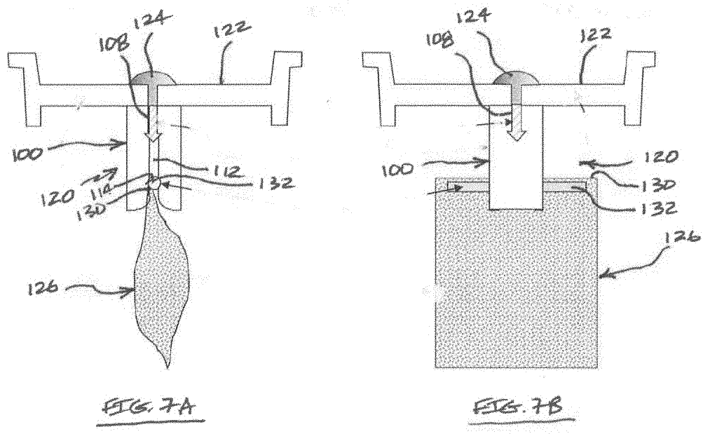

FIGS. 5A, 5B and 6 illustrate an example post 100 as used with an infuser device as disclosed herein, wherein the post 100 comprises a body 102 extending between axial ends 104 and 106. End 104 is configured, as discussed above with respect to other example post constructions, having an attachment feature 108 constructed to promote attachment with a lid of a liquid drinking container. In an example, the attachment feature may be in the form of a recessed opening 110 for accommodating placement of an attachment member (shown in FIGS. 7A and 7B) therein. In an example, the recessed opening 110 may be threaded to accommodate attachment with threaded attachment member in the form of a screw or the like. Other post-lid attachment mechanisms are understood to be within the scope of this disclosure, such as a rivet or pin attachment or the like. Post end 106 is configured to accommodate attachment of an infuser container therein. In this example, the end 106 is configured having a slot or channel 112 extending axially away from the end 106 a desired distance for purposes of retaining the infuser container within the channel or slot and providing a clip attachment therewith. In view thereof, the post 100 may be referred to as an infuser clip. Additionally, ends of the channel 106 may be contoured or tapered for the purposes of facilitating insertion of the infuser container into the channel. In an example, the channel 112 includes opposed internal surface features 114 that operate to engage and retain a complementary retainer element or portion of the infuser container disposed within the channel (shown in FIGS. 7A and 7B). In an example, the surface features 114 may be in the form of transversely positioned recesses. The post 100 may be configured for disposable or reusable use depending on the particular liquid drinking container as noted above for the other example post embodiments, and may be formed form the same types of materials discussed above.

FIGS. 7A and 7B illustrate an example infuser device 120 comprising the infuser post or clip 100 as disclosed above as attached with a liquid drinking container lid 122 through the use of an attachment member 124 that is engaged with the post attachment feature 108. An infuser container 126 is provided comprising a porous body 128 having a desired volume of infusant contained therein. In an example embodiment, the infuser container may be in the form of conventional tea bag or the like comprising a paper, plastic, or cloth porous body 128. The infuser container 126 includes an end 130 that is disposed within the clip channel 112 and that is retained therein by use of a retainer element 132 that is interposed between the channel surface features 114. In an example, the retainer element may be in the form a cylindrical member in the shape of a rod formed from wood or plastic and the like, and that operates to close the opening of the infuser container and fix placement of the infuser container within the clip. The retainer element may be separate or an integral part of the post clip or be separate from or an integral part of the infuser container. In an example embodiment, the retainer element is part of the infuser container. Configured in this manner, the infuser container is snapped into place within the infuser clip to form the infuser device as disclosed herein, wherein the infuser container is held into place within the clip by spring tension proved within the channel. While a particular attachment mechanism has been disclosed for attaching the infuser container to the post, it is to be understood that the post and/or infuser container may be configured differently to provide alternative mechanisms for attachment and that all such alternative attachment mechanisms are intended to be within the scope of this disclosure. In an example, the post is configured having a desired length such that when combined with the infuser container and attached to the lid, the infusant in the infuser container is covered by a level of liquid in a liquid drinking container to thereby cause the infusant to steep.

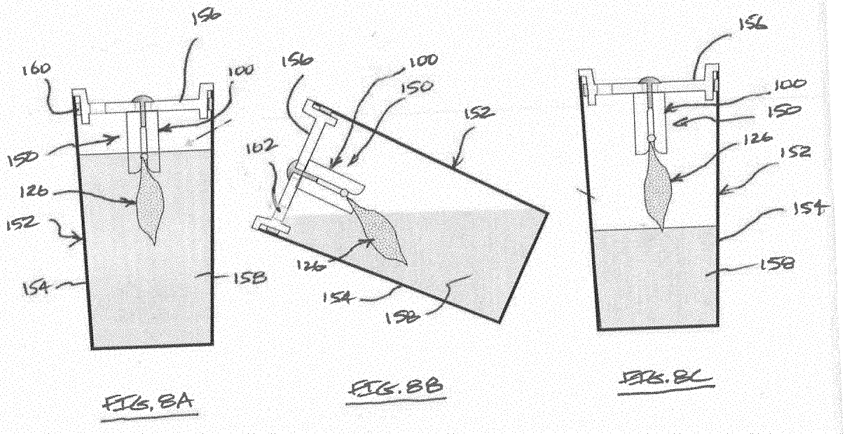

FIGS. 8A to 8C illustrate an example infuser device 150 as disclosed herein as combined within a liquid drinking container 152 comprising a housing 154, a lid 156 disposed over an open end of the drinking container housing, and comprising a volume of liquid 158 within the drinking container. FIG. 8A shows an example infuser device 150 comprising the post or clip 100 as illustrated in FIGS. 5A, 5B, 6, 7A and 7B and described above as attached with an infuser container 126 comprising a volume of infusant therein to be infused by the liquid 158. The lid 156 is removably attached to the housing open end, and in this example includes an optional annular seal 160 to provide a leak-tight seal between the lid and drinking container housing. The infusion device 150 has a post length that is designed to cause the volume of material in the infuser container 126 to be completely immersed by the liquid volume for infusion when the drinking container is in a filled condition. In an example, once the liquid drinking container 152 is in a filled position, it may remain in a vertical position for an amount of time until steeping is complete. After steeping, the infuser device 150, or the infuser container, may be removed from the liquid drinking container 152, or it may remain in place.

FIG. 8B illustrates the relationship of the infuser device 150 to the liquid drinking container 152 and the liquid volume 158 inside the drinking container when the infuser device 150 is left in the drinking container 152 and the drinking container 152 is tilted into a position for use or drinking, or otherwise removing a volume of the liquid volume from the drinking container, e.g., through an opening 162 along a side of the lid 156. As illustrated, in such a use position, the infuser clip 100 position relative to the drinking container does not change, i.e., the infuser clip does not tilt or move radially relative to the drinking container housing. However, the infuser container 126 may tilt an amount relative to the clip. As illustrated, depending on the liquid volume level in the drinking container, when the drinking container 152 is moved into a drinking position, the extent of contact between liquid and the infuser container 126 and the infusant therein may be reduced, and such continues to be reduced as the volume of liquid within the liquid drinking container continues to be reduced through user drinking, thereby operating to reduce the steeping process as the liquid is being removed from the liquid drinking container.

FIG. 8C illustrates the relationship of the infuser device 150 to the liquid drinking container 152 and the liquid volume 158 inside the drinking container when the infuser device is left in the drinking container, the drinking container is in a vertical position, and a sufficient volume of the liquid has been removed from the drinking container so that the liquid no longer contacts the infuser container 120, i.e., the liquid level is below the infuser device, thereby inhibiting further steeping. As noted above, a feature of the infuser device as disclosed herein is that it is specifically configured to limit the amount of steeping of an infusant without having to be removed from a liquid drinking container.

In an example embodiment, the infuser device as comprising the post in the form of a clip as used with infuser container illustrated in FIGS. 7A and 7B may be constructed in the form of a disposable device that may be used with a disposable liquid and lid. Constructed in this manner, once the infuser device is combined with the liquid drinking container and the infusant is steeped, a user can dispose of the entire contents once a desired content of the liquid has been consumed.

A feature of infuser devices, combinations of the same with liquid drinking container, and methods of using the same include the ability to position an infusant within a drinking container of liquid in a manner that avoids oversteeping. A further feature of such infuser device is the ability to provide the same as a disposable component along with a disposable liquid drinking container to promote ease of use and disposal.

The foregoing description and accompanying figures illustrate the principles, preferred embodiments and modes of operation of infuser devices as disclosed herein. However, such infuser devices should not be construed as being limited to the particular embodiments discussed above. Additional variations of the embodiments discussed above will be appreciated by those skilled in the art. Therefore, the above-described embodiments should be regarded as illustrative rather than restrictive. Accordingly, it should be appreciated that variations to those embodiments can be made by those skilled in the art without departing from the scope of infuser devices as defined by the following claims.

What is claimed is:

1. An infuser device for use with a beverage drinking container comprising:
a post extending a length from an attachment point with a lid disposed over a drinking container opening, wherein the post is a rigid construction; and
an infuser container that is attached adjacent an end of the post opposite the lid, wherein the infuser container includes a chamber to accommodate a volume of infusant therein, and wherein at least a portion of the infuser container is porous to facilitate passage of liquid into and out of the chamber;
wherein an axial position of the post relative to a sidewall of the drinking container remains constant independent of a tilt angle of the drinking container.

2. The infuser device as recited in claim 1 wherein the post end opposite the lid is configured to provide a removable attachment with portion of the infuser container.

3. The infuser device as recited in claim 1 wherein the infuser container has a rigid body and is removably attached to the post.

4. The infuser device as recited in claim 1 wherein the infuser container has a movable body and is removably attached to the post.

5. The infuser device as recited in claim 1 wherein the post end opposite the lid comprises a channel configured to accommodate at least a portion of the infuser container therein.

6. The infuser device as recited in claim 5 wherein one or both of the infuser channel and the infuser container include a surface feature or a retainer element configured to complement one another to retain attachment of infuser container in the channel.

7. The infuser device as recited in claim 6 wherein a retainer element is interposed between a portion of the infuser container and the channel and is disposed within a surface feature of the channel.

8. The infuser device as recited in claim 1 wherein the infuser post and infuser container are disposable for use with a disposable beverage drinking container and lid.

9. The infuser device as recited in claim 1 wherein the infuser container is partially or completely covered with liquid disposed in the beverage drinking container when the liquid in the drinking container is in a filled state, and wherein the infuser container is not contacted by the liquid when the liquid in the drinking container is in a used or diminished state caused by removal of the liquid from the drinking container during use.

10. An infuser device for use with a beverage drinking container comprising:
a rigid post having a first end that is attached with a lid disposed over an opening of the drinking container, and having an opposed second end that is disposed axially into the drinking container, wherein the position of the post within the drinking container remains constant independent of a tilt angle of the drinking container; and
an infuser container attached to the post second end and disposed within the drinking container, wherein the infuser container contains a volume of infusant disposed therein;
wherein when the beverage container contains a volume of liquid in a filled state, the infuser container is disposed partially or completely below a surface of the liquid; and wherein when the beverage drinking container contains a diminished volume of liquid in a used state, the infuser container is disposed above the surface of the liquid.

11. The infuser device as recited in claim 10 wherein the post second end is configured to form a releasable attachment with the infuser container.

12. The infuser device as recited in claim 10 wherein the infuser container has a rigid housing and does not move relative to the post when the beverage drinking container tilted to an angle.

13. The infuser device as recited in claim 10 wherein at least a portion of the infuser container is movable relative to the post.

14. The infuser device as recited in claim 10 wherein the infuser container has a non-rigid construction and wherein the volume of infusant is disposed within a porous body, and wherein the porous body extends axially from the post second end.

15. The infuser device as recited in claim 14 wherein an upper portion of the infuser container is disposed in and retained between opposed sections of the post second end.

16. The infuser device as recited in claim 15 wherein one of the post second end and the other of the infuser device includes a retainer element and a surface feature configured to complement the retainer element for retaining attachment of the infuser container with the post.

17. A method for infusing a material with a liquid disposed within a drinking container comprising the steps of:
subjecting an infusant disposed within an infusion container to contact with a liquid, wherein the liquid is disposed within a beverage drinking container, and wherein the infusion container is attached to a post extending from a lid disposed over an opening of the beverage drinking container, wherein the post is rigid and has a fixed axial length; and
controlling an extent of contact of the infusant with the liquid, wherein when the beverage drinking container contains liquid volume in a filled state the liquid is in contact with the infusion container and infusant, and wherein as the liquid is withdrawn from the beverage drinking container during use the extent of contact between the liquid and the infusion container and infusant diminishes to zero.

18. The method as recited in claim 17 wherein the post remains in a fixed position within the beverage drinking container as the beverage drinking container is tilted during use and removal of the liquid by a user.

19. The method as recited in claim 17 wherein the infusion container comprises a movable construction relative to the post.

20. The method as recited in claim 17 wherein the infuser container is attached to an end of the post opposite the lid, and wherein the post end comprises one or a surface feature or a retainer element that cooperates with the other of a surface feature or retainer element of the infuser container for retaining attachment of the post and infuser element.
